(19) United States
(12) Patent Application Publication
(10) Pub. No.: US 2012/0060870 A1
(43) Pub. Date: Mar. 15, 2012

(54) Cleansing Apparatus for Substrate and Cleansing Method for the Same

(75) Inventor: Yong-Woo Kim, Yongin-City (KR)

(73) Assignee: SAMSUNG MOBILE DISPLAY CO., LTD., Yongin-City (KR)

(21) Appl. No.: 13/078,202

(22) Filed: Apr. 1, 2011

(30) Foreign Application Priority Data
Sep. 14, 2010 (KR) 10-2010-0090064

(51) Int. Cl. B08B 3/00

(52) U.S. Cl. 134/29; 134/94.1

(57) ABSTRACT

The invention relates generally to a cleansing apparatus for a substrate and a cleansing method for cleansing byproducts generated after an etching process of the substrate. The cleansing apparatus comprises: a first cleansing device including a first supply unit for providing a first cleansing fluid to an etched substrate; a second cleansing device including a second supply unit for providing a second cleansing fluid to the substrate cleansed by the first cleansing fluid; and a third cleansing device including a third supply unit for providing a third cleansing fluid to the substrate cleansed by the second cleansing fluid. The first cleansing fluid and the third cleansing fluid are pure water (DI water), and the second cleansing fluid is an alkali solution.

### CLAIM OF PRIORITY

This application makes reference to, incorporates the same herein, and claims all benefits accruing under 35 U.S.C. §119 from an application earlier filed in the Korean Intellectual Property Office on Sep. 14, 2010 and there duly assigned Serial No. 10-2010-0090064.

### BACKGROUND OF THE INVENTION

1. Field of the Invention

The present invention relates generally to a cleansing apparatus for a substrate and a cleansing method of the same. More particularly, the invention relates to a cleansing apparatus and a cleansing method for cleansing byproducts generated in an etching process of a substrate.

2. Description of the Related Art

Among display devices, flat panel displays are thin display devices which have a flat and thin profile. Such flat panel displays includes a liquid crystal display (LCD), a plasma display device (PDD), and an organic light emitting diode (OLED) display.

The flat panel display comprises a display panel which displays images, and the display panel is manufactured through several processes, such as an etching process and a cleansing process.

As an example of the liquid crystal display (LCD), in order to form the liquid crystal display panel, two insulation substrates are assembled, and an etching process is performed to reduce the thickness of the assembled substrates. After this etching process is performed, byproducts, such as an etchant used in the etching process or sludge generated by a chemical reaction of the etchant and the substrates, may remain on the substrates.

If the byproducts from the etching process remain on the surface of the substrates for a long time, stains may be generated on the substrates, and as a result, the substrates may be damaged. Accordingly, a cleansing process to remove the byproducts, such as the sludge, is performed after the etching process.

On the other hand, when the cleansing process is manually performed by using a brush or a wiper, removal efficiency of the byproducts is deteriorated. Also, it is difficult to manually perform the cleansing process due to the decreasing of the thickness of the substrates in the etching process. The manufacturing yield of the substrate is deteriorated in the manual cleansing process such that the production time and the production cost may be increased.

Accordingly, in the process for manufacturing the flat panel display, a cleansing process which is capable of removing the byproducts, such as sludge, after the etching process of the substrate is required.

The above information disclosed in this Background section is only for enhancement of an understanding of the background of the invention, and therefore it may contain information that does not form the prior art which is already known in this country to a person of ordinary skill in the art.

### SUMMARY OF THE INVENTION

The present invention provides a cleansing apparatus and a cleansing method for a substrate which are capable of efficiently removing a contaminating material, such as sludge, from a substrate.

A cleansing apparatus for a substrate according to an exemplary embodiment of the invention comprises: a first cleansing device including a first supply unit for providing a first cleansing fluid to an etched substrate; a second cleansing device including a second supply unit for providing a second cleansing fluid to the substrate cleansed by the first cleansing fluid; and a third cleansing device including a third supply unit for providing a third cleansing fluid to the substrate cleansed by the second cleansing fluid; wherein the first cleansing fluid and the third cleansing fluid are pure water (DI water), and the second cleansing fluid is an alkali solution.

The second cleansing fluid may be formed by mixing sodium hydroxide and pure water.

The acidity of the second cleansing fluid may be more than pH 7 and less than pH 14.

The cleansing apparatus may further comprise: a supply chamber for storing the second cleansing fluid; and a pump disposed between the supply chamber and the second cleansing device for supplying the second cleansing fluid to the second supply unit of the second cleansing device.

The supply chamber may include: a first supply chamber for storing a hydroxide; a second supply chamber for storing pure water; and a mixing chamber for storing the second cleansing fluid mixed with the hydroxide and the pure water supplied from the first supply chamber and the second supply chamber, respectively.

The first supply unit may include a first supply pipe for supplying the first cleansing fluid and a first nozzle in communication with the first supply pipe and injecting the first cleansing fluid onto the substrate. The second supply unit may include a second supply pipe for supplying the second cleansing fluid and a second nozzle in communication with the second supply pipe and injecting the second cleansing fluid onto the substrate. The third supply unit may include a third supply pipe for supplying the third cleansing fluid and a third nozzle in communication with the third supply pipe and injecting the third cleansing fluid onto the substrate.

The cleansing apparatus may further include: a fixing frame for fixing the substrate; and a transferring unit for sequentially transferring the fixing frame to the first cleansing device, the second cleansing device, and the third cleansing device.

The cleansing apparatus may further include a drying device for providing a gas to dry the substrate cleansed by the third cleansing fluid in the third cleansing device.

The substrate may include a first substrate and a second substrate which are formed of glass and assembled.

A cleansing method for a substrate according to an exemplary embodiment of the invention comprises: a first cleansing step of providing a first cleansing fluid through a first supply unit to a substrate having undergone an etching process; a second cleansing step of providing a second cleansing fluid through a second supply unit to the substrate cleansed by the first cleansing fluid; and a third cleansing step of providing a third cleansing fluid through a third supply unit to the substrate cleansed by the second cleansing fluid; wherein the first cleansing fluid and the third cleansing fluid are pure water, and the second cleansing fluid is an alkali solution.

The second cleansing fluid may be formed by mixing sodium hydroxide and the pure water.

The acidity of the second cleansing fluid may be more than pH 7 and less than pH 14.

The second cleansing fluid may be formed by mixing a hydroxide and the pure water in a mixing chamber, and supplying the second cleansing fluid, through a pump connected to the mixing chamber and to the second supply unit, to the second supply unit.

The first supply unit, the second supply unit, and the third supply unit may each include a supply pipe and a nozzle, and the first cleansing fluid, the second cleansing fluid, and the third cleansing fluid may be injected onto the substrate through the respective nozzles.

The substrate may be fixed to a fixing frame, and is transmitted through a transferring unit, so that the substrate sequentially passes through the first supply unit, the second supply unit, and the third supply unit.

The method may further include a drying step of providing a gas to the substrate so as to dry the substrate.

The substrate may be formed by assembling a first substrate and a second substrate which are made of glass.

According to an exemplary embodiment, the substrate contamination material, such as the sludge generated in the etching process, may be effectively removed through the alkali cleansing.

Also, the cleansing effect may be maximized and, simultaneously, the process time and the cost may be reduced according to an auto process.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram of a substrate processing device including a cleansing apparatus according to an exemplary embodiment of the invention.

FIG. 2 is a view of a cleansing device of the cleansing apparatus according to an exemplary embodiment of the invention.

FIG. 3 is a view of one side of the cleansing device of FIG. 2.

FIG. 4 is a schematic view of a first cleansing process according to an exemplary embodiment of the invention.

FIG. 5 is a schematic view of a second cleansing process according to an exemplary embodiment of the invention.

FIG. 6 is a schematic view of the third cleansing process according to an exemplary embodiment of the invention.

FIG. 7 is a photograph of a substrate formed with sludge after etching.

FIG. 8A and FIG. 8B are photographs of a substrate passing through a cleansing process according to an exemplary embodiment of the invention and according to a comparative example, respectively.

### DETAILED DESCRIPTION OF THE INVENTION

Hereinafter, exemplary embodiments of the invention will be described in detail such that those skilled in the art can easily implement them with reference to the accompanying drawings.

To clearly describe the exemplary embodiments, parts not related to the description are omitted, and like reference numerals designate like constituent elements throughout the specification.

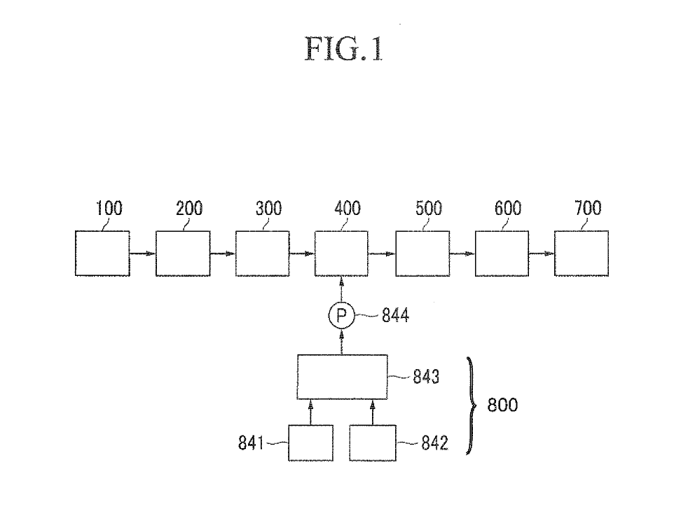

FIG. 1 is a schematic diagram of a substrate processing apparatus including a cleansing apparatus according to an exemplary embodiment of the invention.

Referring to FIG. 1, a substrate processing apparatus according to the present invention includes a substrate mounting device 100, an etching device 200, a cleansing apparatus including a first cleansing device 300, a second cleansing device 400, a third cleansing device 500, and a drying device 600, and a substrate coupling/decoupling device 700. The substrate is mounted and fixed to a fixing frame in the substrate mounting device 100, and is surface-treated while sequentially passing through the etching device 200 and the cleansing apparatus 300, 400, 500, and 600, and is then separated from the fixing frame by the substrate coupling/decoupling device 700.

In the etching device 200, an etchant is provided to the substrate which is mounted on the fixing frame and transferred. The etchant contacts the surface of the substrate and generates a chemical reaction, which reduces the thickness of the substrate. In the present exemplary embodiment, in order to etch a transparent glass used in the liquid crystal display (LCD), etc., an etchant including hydrofluoric acid (HF) reacted with silicon is used.

As described above, in the process of etching the substrate by using the etchant including hydrofluoric acid, sludge may be generated by a chemical reaction of fluorine ions and the substrate surface, a portion of the etchant may remain without being chemically reacted, and the sludge and the remaining etchant are present at the substrate surface, particularly at the edge of the substrate.

A cleansing process of the substrate is performed in order to remove the byproducts, such as sludge. In the present exemplary embodiment, for the cleansing of the substrate, the substrate which is mounted on the fixing frame and passed through the etching device 200 sequentially passes through the first cleansing device 300, the second cleansing device 400, and the third cleansing device 500. In the first cleansing device 300, the second cleansing device 400, and the third cleansing device 500, a first cleansing fluid, a second cleansing fluid, and a third cleansing fluid are respectively provided to the substrate, and in the present exemplary embodiment, pure water (DI water) is used as the first cleansing fluid, an alkali solution is used as the second cleansing fluid, and pure water is again used as the third cleansing fluid. The detailed configuration of each of the cleansing devices 300, 400, and 500 will be described later.

The substrate passed through the cleansing process may be transferred to a drying device 600 for drying the substrate. In the drying device 600, a gas is provided to the substrate surface for evaporation of moisture, and the gas for drying may be air or inactive nitrogen.

The etching device 200 and the drying device 600 have structures similar to the cleansing devices 300, 400 and 500 which will be described later, so that a detailed description of the configuration thereof is omitted here.

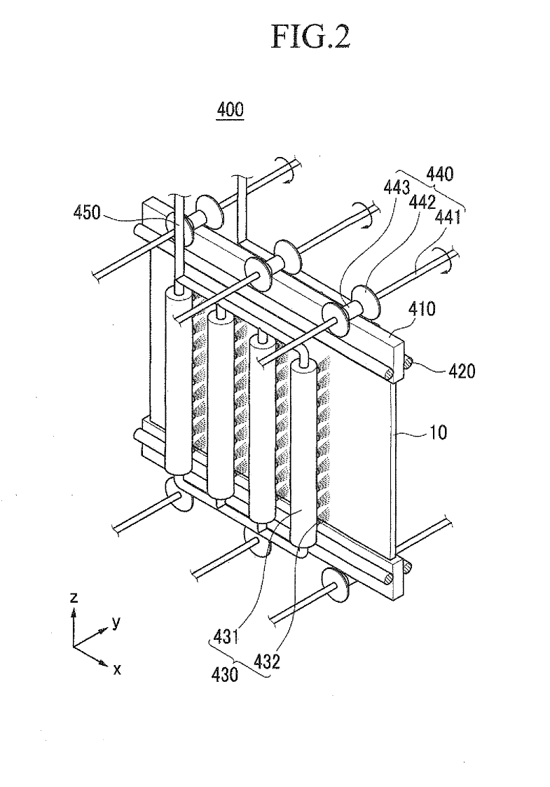

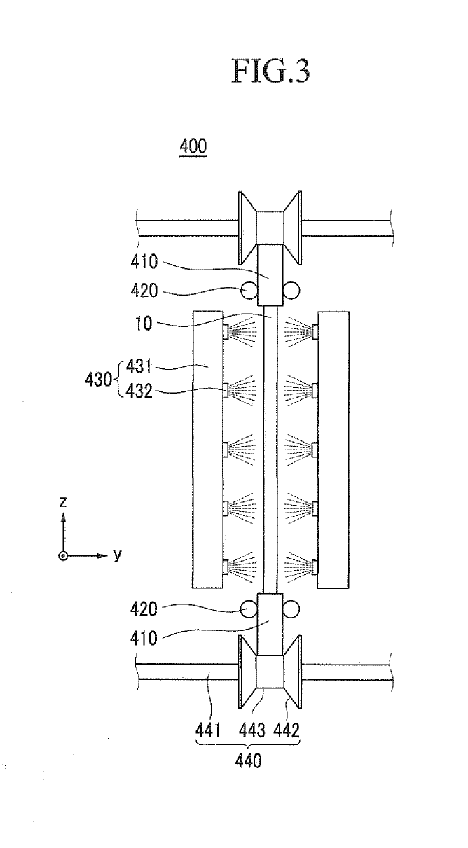

FIG. 2 is a view of a cleansing device according to an exemplary embodiment of the invention, and FIG. 3 is a view of one side of the cleansing device of FIG. 2. Hereinafter, the cleansing devices 300, 400 and 500 of the cleansing the apparatus according to the present exemplary embodiment will be described with reference to the above drawings. A connection pipe 450 is omitted in FIG. 3 for convenience.

In FIGS. 2 and 3, only the second cleansing device 400 is shown. However, the structures of the first cleansing device 300 and the third cleansing device 500 are similar to that of the second cleansing device 400 so that the view and description thereof are omitted.

Referring to FIGS. 2 and 3, the second cleansing device 400 according to the present exemplary embodiment includes a supply unit 430 for supplying a cleansing fluid and a transferring unit 440 for transferring a fixing frame 410 mounting the substrate 10.

The supply unit 430 is disposed on both sides of the substrate 10 fixed to the fixing frame 410 so as to be symmetrical. Each of the pair of supply units 430 includes a supply pipe 431 and a nozzle 432. A plurality of supply pipes 431 are formed along the horizontal direction (x-axis direction) of the substrate 10, and each supply pipe 431 extends in the vertical direction (z-axis direction) of the substrate 10. The nozzle 432 is formed so as to be in communication with the supply pipe 431, thereby receiving the second cleansing fluid from the supply pipe 431 and injecting it onto both surfaces of the substrate 10. The plurality of nozzles 432 may be disposed at uniform intervals. When the injection angle of the nozzle 432 is excessively large or small, the cleansing fluid is concentrated and injected at a narrow range, or is spread and injected at a wide range so that uniform cleansing may not be executed. Thus, it is preferable that the injection angle of the nozzle 432 be in the range of about 30° to about 75°.

On the other hand, in the present exemplary embodiment, the nozzle 432 is an injection nozzle of a point injection type. However, the present invention is not limited thereto, and the nozzle may be formed as a slit nozzle of a line discharging type which uniformly injects the fluid in a line of a predetermined direction.

The supply unit 430 is connected to an external supply chamber through the connection pipe 450. Referring to FIG. 1, the second cleansing device 400 is connected to an external supply chamber 800, and the second cleansing fluid is supplied to the second cleansing device 400 through a pump 844 which is connected to both the supply chamber 800 and the second cleansing device 400, and which is disposed therebetween. In the present exemplary embodiment, an alkali solution is used as the second cleansing fluid and, for this purpose, the supply chamber 800 includes a first supply chamber 841 for supplying a hydroxide such as sodium hydroxide (NaOH), a second supply chamber 842 for providing pure water, and a mixing chamber 843 for receiving and mixing the hydroxide and the pure water. That is, the hydroxide and the pure water are mixed in the mixing chamber 843 so as to form an alkali solution used as the second cleansing fluid, and the alkali solution is passed through the connection pipe 450 (FIG. 2) of the second cleansing device 400 through the pump 844 (FIG. 1) and is supplied to the supply unit 430 (FIG. 2).

On the other hand, in the first cleansing device 300 and the third cleansing device 500, a mixing chamber for forming the cleansing fluid is not necessary, and the pure water may be supplied from the supply chamber to the cleansing devices 300 and 500 through a pump.

Referring to FIGS. 2 and 3, the transferring unit 440 includes a driving shaft 441 and a roller 442. Driving shafts 441 may be formed on the upper portion and the lower portion (z-axis direction) of the substrate 10 which is mounted to the fixing frame 410, and are symmetrical, and the plurality of driving shafts 441 may be disposed along the transferring direction (x-axis direction) of the substrate 10. The roller 442 is connected to and installed on each driving shaft 441, and has a groove portion 443 formed at the center part thereof so that one surface of the fixing frame 410 is mounted thereto. In this case, the groove portion 443 of the roller 442 may be formed so as to correspond to the width of the fixing frame 410 contacted thereby.

Through this configuration, when the driving shaft 441 is rotated in the direction indicated by the arrow of FIG. 2, the roller 442 is rotated in the same direction, and the fixing frame 410 in the state of being mounted to the groove portion 443 is transferred in the negative x-axis direction according to the rotation of the roller 442.

In the present exemplary embodiment, to prevent the substrate 10 from being vibrated or inclined during the transferring process of the fixing frame 410 by the vibration and the impact, the fixing frame 410 is supported and fixed by a support 420. The support 420 extends in the x-axis direction and is disposed so as to be symmetrical via the fixing frame 410, thereby supporting the fixing frame 410 at both sides.

On the other hand, in FIGS. 2 and 3, the upper portion and the lower portion (z-axis direction) of the substrate 10 are fixed to the fixing frame 410, but the fixing frame 410 may be coupled to the right portion and the left portion (x-axis direction) of the substrate 10 so as to fix the substrate 10. That is, the fixing frame 410 as a configuration to stably fix and transfer the substrate 10 may be variously changed by a person of ordinary skill in the art.

As described above, the substrate 10 is fixed to the fixing frame 410, and is cleansed by the second cleansing fluid injected from the nozzle 432 of the supply unit 430 while the substrate 10 is transferred in the x-axis direction by the transferring unit 440. According to the present exemplary embodiment, the cleansing process of the substrate 10 may not be manually performed, but may be automatically performed so that the cleansing efficiency of the substrate 10 having a thin thickness may be increased, and work errors may be reduced so that defect generation may be suppressed. Accordingly, the yield of the process is improved such that the production time and cost of the substrate 10 may be reduced.

On the other hand, it is necessary to adjust the cleansing time and the amount of cleansing fluid used when considering the size of the substrate 10 and the generation degree of the byproducts from the etching, and the cleansing time and amount of cleansing fluid used may be simply adjusted by controlling the rotation speed of the driving shaft 441 of the transferring unit 440 and the injection speed of the nozzle 432 of the supply unit 430.

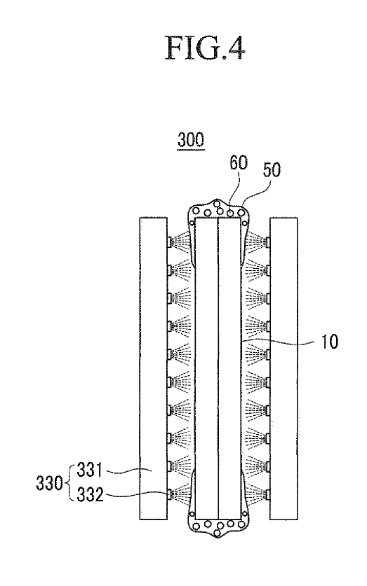

FIGS. 4 thru 6 are views of the first, second and third cleansing processes, respectively, according to an exemplary embodiment of the invention. The cleansing processes according to the present exemplary embodiment will be described with reference to those figures. For better comprehension and ease of description, the fixing frame of the substrate and the transferring unit are omitted in FIGS. 4 thru 6.

As described above, in the present exemplary embodiment, the etchant including hydrofluoric acid is used to etch the substrate made of glass such that sludge is generated in the etching process, and a portion of the etchant remains without being chemical reacted. The sludge and the partial etchant mainly exist at the edge of the substrate. The sludge initially exists in a gel state, and then assumes a solid state after it is dried, and moisture is removed such that the surface of the substrate may be damaged and stains may be generated. Furthermore, the substrate may be undesirably over-etched by the remaining etchant.

Accordingly, in the present exemplary embodiment, in order to efficiently remove the byproducts such as sludge, the substrate is cleansed through the three steps of first, second and third cleansings.

Referring to FIG. 4, the substrate 10, having passed through the etching process, is transferred to the first cleansing device 300 for execution of the first cleansing. The first cleansing device 300 includes a supply unit 330, and the supply unit 330 includes a supply pipe 331 supplied with the first cleansing fluid through a connection pipe and a nozzle 332 in communication with the supply pipe 331. The nozzle 332 receives the first cleansing fluid from the supply pipe 331, and injects the first cleansing fluid onto both sides of the substrate 10, so that the surface of the substrate 10 is cleansed.

In the present exemplary embodiment, pure water is used as the first cleansing fluid. However, the sludge is not completely removed through the first cleansing using the pure water, and byproducts 50, of which the sludge (such as AlF₃, MgF₂, CaF₂, and BaF₂) is mixed with moisture, remains. Also, the remaining etchant exists as diluted etchant 60 in a H⁺, NH₄⁺, or F⁻ state.

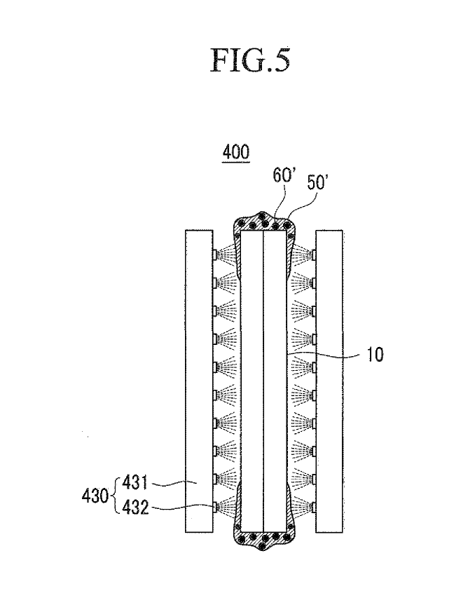

Referring to FIG. 5, the substrate 10, having passed through the first cleansing, is transferred to the second cleansing device 400 for the second cleansing. As described above, the second cleansing device 400 includes the supply unit 430, which includes the supply pipe 431 supplied with the second cleansing fluid through the connection pipe, and the nozzle 432 which is in communication with the supply pipe 431. The nozzle 432 receives the second cleansing fluid from the supply pipe 431, and injects it onto both sides of the substrate 10 so as to cleanse the surface of the substrate 10.

In the present exemplary embodiment, an alkali solution is used as the second cleansing fluid. The alkali solution has acidity of more than pH 7 and less than pH 14, and for this purpose, in the present exemplary embodiment, sodium hydroxide is mixed with the pure water to form an alkali solution. However, the present invention is not limited thereto, and an alkali solution of various states may be formed by mixing hydroxide and water, as well as sodium hydroxide.

This alkali solution is provided to the substrate 10 such that the acid component included in the diluted etchant 60 is neutralized. In detail, a neutralization solution 60′ (including H₂O, NH₄OH, and NaF) is formed through chemical reaction of the diluted etchant 60 (including H⁺, NH₄⁺, and F⁻) and the second cleansing fluid (including Na⁺ and OH⁻). In the neutralization process, a salt is generated and the volume of sludge 50′ is also increased, and accordingly it is easy to remove the byproducts.

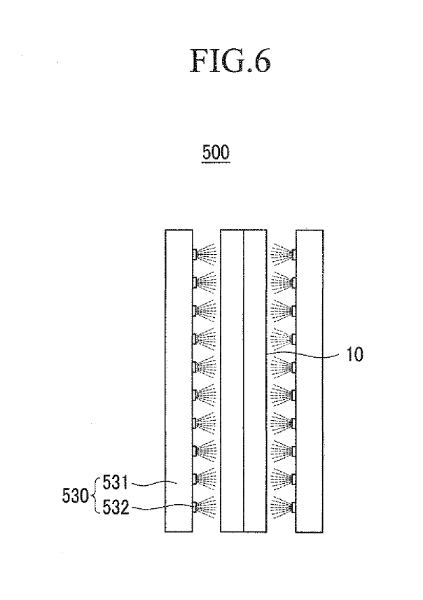

Referring to FIG. 6, the substrate 10, having passed through the second cleansing, is transferred to the third cleansing device 500 for the execution of the third cleansing. The third cleansing device 500 includes a supply unit 530, and the supply unit 530 includes a supply pipe 531 supplied with the third cleansing fluid through the connection pipe, and a nozzle 532 in communication with the supply pipe 531. The nozzle 532 receives the third cleansing fluid from the supply pipe 531, and injects it onto both sides of the substrate 10 so as to cleanse the surface of the substrate 10.

In the present exemplary embodiment, the pure water is used as the third cleansing fluid, and the neutralization solution 60′, including the salt and the sludge 50′ which are formed in the second cleansing, may be removed through pure water cleansing.

As described above, the byproducts such as the sludge generated in the etching process may be effectively removed through three steps of pure water cleansing, alkali cleansing, and pure water cleansing. Also, the cleansing process is not manually performed but is automatically realized such that the process efficiency may be improved, and the damage to the substrate from the manual process may be prevented.

In the present exemplary embodiment, the substrate 10 is made of glass and may include a first substrate and a second substrate that are assembled to each other. In the example of the liquid crystal display (LCD), the first substrate may be a thin film transistor array panel and the second substrate may be a color filter panel. In the example of the organic light emitting diode (OLED) display, the first substrate may be a display panel and the second substrate may be an encapsulation panel. As described above, in the present exemplary embodiment, the etching and the cleansing processes may be performed in the state in which the first substrate and the second substrate are assembled such that the process efficiency may be improved.

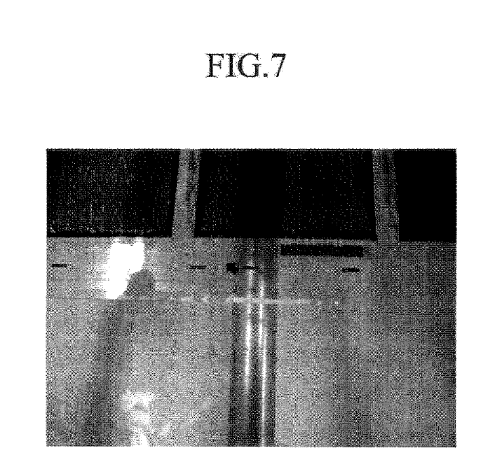

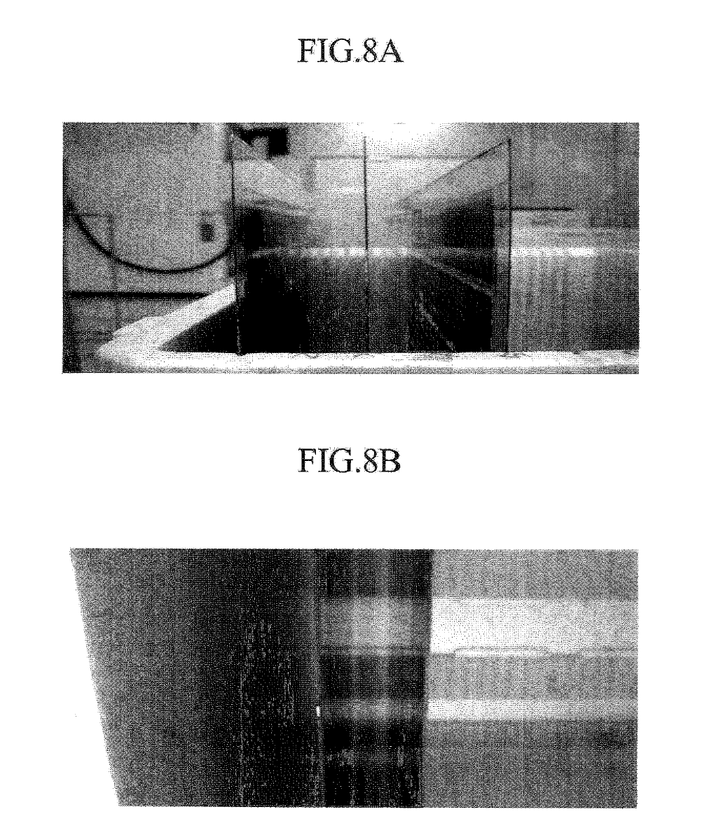

FIG. 7 is a photograph of a substrate formed with sludge after etching, and FIGS. 8A and 8B are photographs of a substrate passing through a cleansing process according to an exemplary embodiment of the invention and a comparative example, respectively. Effects according to an exemplary embodiment will be described with reference to them.

Referring to FIG. 7, the substrate which has not passed through the cleansing after the etching of the substrate shows byproducts, such as sludge, remaining at the edge portion.

FIG. 8A shows the substrate having passed through the cleansing after the etching process, differently from the previous condition. The substrate of the left side has only passed through the pure water cleansing without the alkali cleansing, and the substrates of the center and the right side have passed through the alkali cleansing. Referring to FIG. 8A, the substrate, only having undergone the pure water cleansing after the etching process, has a sludge removal ratio of about 30%. However, the substrate added with the alkali cleansing has a sludge removal ratio of about 90%. Accordingly, it is confirmed that the byproducts, such as sludge, may be effectively removed through three cleansings including the pure water cleansing and alkali cleansing, according to an exemplary embodiment of the invention.

FIG. 8B shows results after controlling the time of the alkali cleansing in the cleansing process, wherein the substrate of the left side has undergone the alkali cleansing for about 22 seconds, and the substrate of the right side has undergone the alkali cleansing for about 30 seconds. Referring to FIG. 8B, the left substrate and the right substrate each have a sludge removal ratio of more than about 99%. Accordingly, it is confirmed that most of the sludge may be removed by executing the alkali cleansing for more than a predetermined time in the cleansing process. On the other hand, when the alkali cleansing time is controlled according to the concentration of the alkali solution, as the concentration of the alkali solution is large such that the pH value is increased, the alkali cleansing time may be decreased.

As described above, the cleansing apparatus and the cleansing method of the substrate according to an exemplary embodiment of the invention may effectively remove the byproducts, such as sludge, generated in the etching process.

The cleansing apparatus and the cleansing method of the substrate, according to an exemplary embodiment, which is applied to a panel for a flat panel display, may be applied to a panel used for a liquid crystal display (LCD) and an organic light emitting diode (OLED) display.

While this disclosure has been set forth in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A cleansing apparatus for a substrate, the apparatus comprising:
a first cleansing device including a first supply unit for providing a first cleansing fluid to an etched substrate;
a second cleansing device including a second supply unit for providing a second cleansing fluid to the substrate cleansed by the first cleansing fluid; and
a third cleansing device including a third supply unit for providing a third cleansing fluid to the substrate cleansed by the second cleansing fluid;
wherein the first cleansing fluid and the third cleansing fluid are pure water (DI water), and the second cleansing fluid is an alkali solution.

2. The cleansing apparatus of claim 1, wherein the second cleansing fluid is formed by mixing sodium hydroxide and pure water.

3. The cleansing apparatus of claim 1, wherein an acidity of the second cleansing fluid is more than pH 7 and less than pH 14.

4. The cleansing apparatus of claim 1, further comprising:
a supply chamber for storing the second cleansing fluid; and
a pump disposed between the supply chamber and the second cleansing device for supplying the second cleansing fluid to the second supply unit of the second cleansing device.

5. The cleansing apparatus of claim 4, wherein the supply chamber includes:
a first supply chamber for storing a hydroxide;
a second supply chamber for storing pure water; and
a mixing chamber for storing the second cleansing fluid mixed with the hydroxide and the pure water supplied from the first supply chamber and the second supply chamber, respectively.

6. The cleansing apparatus of claim 1, wherein:
the first supply unit includes a first supply pipe for supplying the first cleansing fluid, and a first nozzle in communication with the first supply pipe for injecting the first cleansing fluid onto the substrate;
the second supply unit includes a second supply pipe for supplying the second cleansing fluid, and a second nozzle in communication with the second supply pipe for injecting the second cleansing fluid onto the substrate; and
the third supply unit includes a third supply pipe for supplying the third cleansing fluid, and a third nozzle in communication with the third supply pipe and injecting the third cleansing fluid onto the substrate.

7. The cleansing apparatus of claim 1, further comprising:
a fixing frame for fixing the substrate; and
a transferring unit for sequentially transferring the fixing frame to the first cleansing device, the second cleansing device, and the third cleansing device.

8. The cleansing apparatus of claim 1, further comprising a drying device for providing a gas to dry the substrate cleansed by the third cleansing fluid in the third cleansing device.

9. The cleansing apparatus of claim 1, wherein the substrate includes a first substrate and a second substrate which are formed of glass and assembled.

10. A method of cleansing a substrate, comprising the steps of:
a first cleansing step of providing a first cleansing fluid through a first supply unit to a substrate having undergone an etching process;
a second cleansing step of providing a second cleansing fluid through a second supply unit to the substrate cleansed by the first cleansing fluid; and
a third cleansing step of providing a third cleansing fluid through a third supply unit to the substrate cleansed by the second cleansing fluid;
wherein the first cleansing fluid and the third cleansing fluid are pure water, and the second cleansing fluid is an alkali solution.

11. The method of claim 10, wherein the second cleansing fluid is formed by mixing sodium hydroxide and the pure water.

12. The method of claim 10, wherein an acidity of the second cleansing fluid is more than pH 7 and less than pH 14.

13. The method of claim 10, wherein the second cleansing fluid is formed by mixing a hydroxide and the pure water in a mixing chamber, and supplying the second cleansing fluid through a pump connected to the mixing chamber and to the second supply unit to the second supply unit.

14. The method of claim 10, wherein each of the first supply unit, the second supply unit, and the third supply unit includes a supply pipe and a nozzle, and the first cleansing fluid, the second cleansing fluid, and the third cleansing fluid are injected onto the substrate through the respective nozzles.

15. The method of claim 10, wherein the substrate is fixed to a fixing frame and is transmitted through a transferring unit so that the substrate sequentially passes through the first supply unit, the second supply unit, and the third supply unit.

16. The method of claim 10, further comprising a drying step of providing a gas to the substrate so as to dry the substrate.

17. The method of claim 10, wherein the substrate is formed by assembling a first substrate and a second substrate which are made of glass.
